(19) United States
(12) Patent Application Publication
(10) Pub. No.: US 2026/0080892 A1
(43) Pub. Date: Mar. 19, 2026

(54) EMOTION ESTIMATION METHOD

(71) Applicant: TOYOTA JIDOSHA KABUSHIKI KAISHA, Toyota-shi (JP)

(72) Inventor: Ryosuke TACHIBANA, Tokyo (JP)

(73) Assignee: TOYOTA JIDOSHA KABUSHIKI KAISHA, Toyota-shi (JP)

(21) Appl. No.: 19/298,690

(22) Filed: Aug. 13, 2025

(30) Foreign Application Priority Data
Sep. 19, 2024 (JP) 2024-162663

(51) Int. Cl. G10L 25/63; G10L 25/30

(52) U.S. Cl. CPC G10L 25/63; G10L 25/30

(57) ABSTRACT

An emotion estimation method executed by an information processing device, comprising: acquiring speech data; inputting speech data into a learning model; separating the speech data into first vector data and second vector data; inputting the first vector data into a first estimation model to estimate emotion based on linguistic information; and inputting the second vector data into a second estimation model to estimate emotion based on non-linguistic information, wherein part of teacher data used in training the first estimation model and the second estimation model is given a pseudo label instead of a label, and the first estimation model and the second estimation model are trained by semi-supervised learning.

### CROSS-REFERENCE TO RELATED APPLICATION

This application claims priority to Japanese Patent Application No. 2024-162663 filed on Sep. 19, 2024. The disclosure of the above-identified application, including the specification, drawings, and claims, is incorporated by reference herein in its entirety.

### BACKGROUND

### 1. Technical Field

The present disclosure relates to an emotion estimation method.

### 2. Description of Related Art

Conventionally, there is known technology for analyzing contents of a business negotiation. For example, Japanese Unexamined Patent Application Publication No. 2019-28910 (JP 2019-28910 A) discloses a dialogue analysis system that checks whether a sales representative in a business negotiation with a customer communicates matters that should be communicated, and does not state matters that should not be stated.

### SUMMARY

Success or failure of business negotiations can be related to emotions of customers. JP 2019-28910 A does not disclose estimating emotions of a customer or the like, utilizing machine learning or the like. Also, being able to estimate emotions from speech data could lead to improved quality and so forth of customer service and customer support, not only in business negotiations but on a broader scale, but emotion estimation technology has not been sufficiently studied heretofore. In this way, there is room for improvement in emotion estimation technology.

In view of the foregoing circumstances, an object of the present disclosure is to improve emotion estimation technology.

An emotion estimation method according to an embodiment of the present disclosure is an emotion estimation method that is executed by an information processing device, the emotion estimation method including
acquiring speech data,
inputting the speech data into a learning model, and separating into first vector data and second vector data,
inputting the first vector data into a first estimation model and estimating an emotion based on linguistic information, and
inputting the second vector data into a second estimation model and estimating an emotion based on non-linguistic information, in which
part of teacher data that is used when training the first estimation model and the second estimation model is imparted a pseudo label instead of a label, and the first estimation model and the second estimation model are trained by semi-supervised learning.

According to the embodiment of the present disclosure, emotion estimation technology is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block-diagram illustrating a schematic configuration of a system according to an embodiment of the present disclosure; and

FIG. 2 is a flowchart illustrating an operation of the information processing device.

### DETAILED DESCRIPTION OF EMBODIMENTS

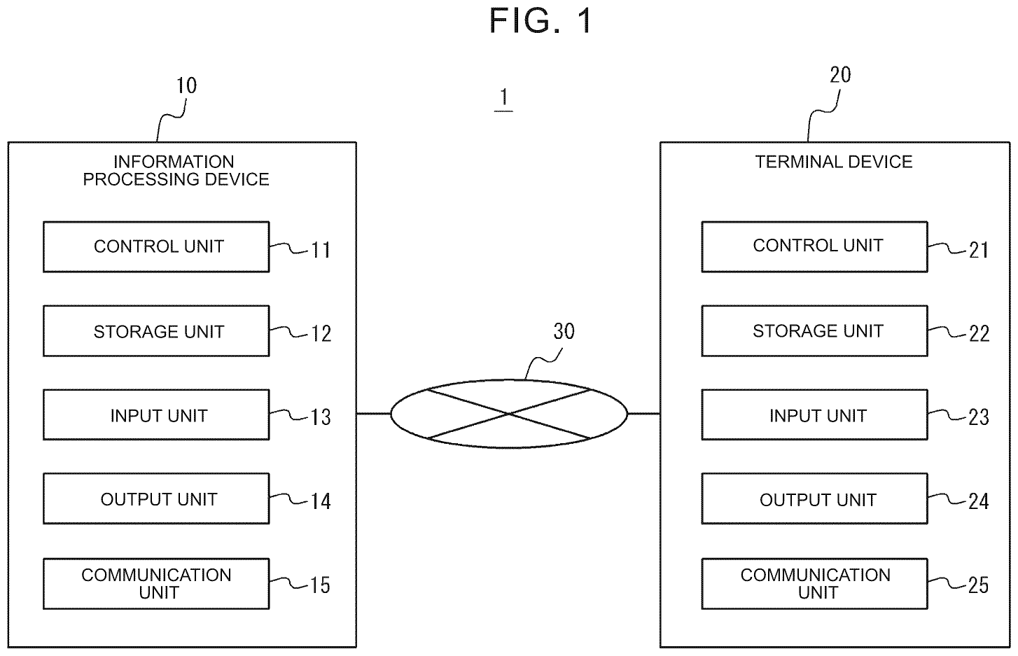

Hereinafter, an embodiment of the present disclosure will be described. An outline and a configuration of the system 1 according to the present embodiment will be described with reference to FIG. 1. The system 1 according to the present embodiment includes an information processing device 10 and a terminal device 20. The information processing device 10 is, for example, a server apparatus installed in a data center or the like. The terminal device 20 is any device used by each user. These devices are communicably connected via a network 30 such as the Internet. Although one each of the information processing device 10 and the terminal device 20 is illustrated in FIG. 1, the system 1 may include a plurality of these apparatuses.

First, an outline of the emotion estimation technique according to the present embodiment will be described, and details will be described later. The emotion estimation technique according to the present embodiment is executed by the information processing device 10. First, the information processing device 10 acquires speech data such as an opportunity. The information processing device 10 inputs the speech data to the learning model and separates the speech data into at least the first vector data and the second vector data. The information processing device 10 estimates an emotion corresponding to the speech data based on at least the first vector data and the second vector data. The learning model is trained on the basis of a first loss function based on the difference between the linguistic information based on the speech data and the first vector data, a second loss function based on the symmetric learning or the asymmetric learning of the second vector data, and a third loss function minimizing the mutual information amount between the first vector data and the second vector data.

As described above, according to the present embodiment, the information processing device 10 inputs the speech data to the learning model and separates the speech data into at least the first vector data and the second vector data. The learning model is trained based on a first loss function, a second loss function, and a third loss function. Therefore, according to the present embodiment, emotion estimation using at least two different vectors can be performed. Specifically, two emotions, an expressive emotion and an intrinsic emotion, can be estimated by at least the first vector data and the second vector data, respectively. Expressed emotion is an emotion expressed through linguistic information. The intrinsic emotion is an emotion in the mind or an emotion that is not expressed as linguistic information. In other words, the intrinsic emotion is an emotion expressed through at least one of paralinguistic information and non-linguistic information. The linguistic information is information indicating utterance content based on speech data. The paralinguistic information is information such as an emotion, an attitude, and an intention based on speech data. The non-linguistic information is information on the age, sex, and the like of the speaker based on the speech data. As described above, according to the present embodiment, the emotion estimation technique is improved in that it is possible to estimate emotions having different properties and further estimate differences in these emotions (hereinafter, also referred to as emotion gaps).

Next, the configurations of the information processing device 10 and the terminal device 20 will be described in detail. As illustrated in FIG. 1, the information processing device 10 includes a control unit 11, a storage unit 12, an input unit 13, an output unit 14, and a communication unit 15. The control unit 11 includes at least one processor. The processor may be a general-purpose processor such as a CPU or a special-purpose processor specialized for a particular process. The control unit 11 executes processing related to the operation of the information processing device 10 while controlling each unit of the information processing device 10. The storage unit 12 includes at least one semiconductor memory or the like. The semiconductor memory is, for example, a RAM or a ROM. The storage unit 12 functions as, for example, a main storage device, an auxiliary storage device, or the like. The storage unit 12 stores data used for the operation of the information processing device 10 and data acquired through the operation of the information processing device 10. For example, the storage unit 12 stores a learning model. The learning model is a model created by machine learning using a machine learning algorithm. The learning model may be, for example, a machine learning model constructed based on a decision tree, Convolutional Neural Network (CNN), Recurrent Neural Network (RNN), or a model generated based on a machine learning algorithm such as deep learning. The input unit 13 includes at least one input interface. The input interface may be, for example, a physical key, a touch screen, a sound sensor that accepts voice input, a camera that accepts gesture input, or the like. The input unit 13 receives an operation of inputting data used for the operation of the information processing device 10. The output unit 14 includes at least one output interface. The output interface is, for example, a display for video output of information, a speaker for audio output of information, or the like. The output unit 14 outputs data obtained by the operation of the information processing device 10. The communication unit 15 includes at least one external communication interface. The communication interface may be any interface of wired communication or wireless communication. For wired communication, the communication interfaces are, for example, LAN, USB. For wireless communication, the communication interface is, for example, an interface corresponding to a mobile communication standard such as a 5G or an interface corresponding to short-range wireless communication. The communication unit 15 receives data used for the operation of the information processing device 10 and transmits data obtained by the operation of the information processing device 10.

As illustrated in FIG. 1, the terminal device 20 includes a control unit 21, a storage unit 22, an input unit 23, an output unit 24, and a communication unit 25. The control unit 21 includes at least one processor. The processor may be a general-purpose processor such as a CPU or a special-purpose processor specialized for a particular process. The control unit 21 executes processing related to the operation of the terminal device 20 while controlling each unit of the terminal device 20. The storage unit 22 includes at least one semiconductor memory or the like. The semiconductor memory is, for example, a RAM or a ROM. The storage unit 22 functions as, for example, a main storage device, an auxiliary storage device, or the like. The storage unit 22 stores data used for the operation of the terminal device 20 and data obtained by the operation of the terminal device 20. The input unit 23 includes at least one input interface. The input interface may be, for example, a physical key, a touch screen, a sound sensor that accepts voice input, a camera that accepts gesture input, or the like. The input unit 23 receives an operation of inputting data used for the operation of the terminal device 20. The output unit 24 includes at least one output interface. The output interface is, for example, a display for video output of information, a speaker for audio output of information, or the like. The output unit 24 outputs data obtained by the operation of the terminal device 20. The communication unit 25 includes at least one external communication interface. The communication interface may be any interface of wired communication or wireless communication. For wired communication, the communication interfaces are, for example, LAN, USB. For wireless communication, the communication interface is, for example, an interface corresponding to a mobile communication standard such as a 5G or an interface corresponding to short-range wireless communication. The communication unit 25 receives data used for the operation of the terminal device 20 and transmits data obtained by the operation of the terminal device 20.

The function of the information processing device 10 or the terminal device 20 is realized by executing the program according to the present embodiment by a processor corresponding to the control unit 11 or the control unit 21. That is, the functions of the information processing device 10 or the terminal device 20 are realized by software. The program causes the computer to execute the operation of the information processing device 10 or the terminal device 20, thereby causing the computer to function as the information processing device 10 or the terminal device 20. That is, the computer functions as the information processing device 10 or the terminal device 20 by executing the operation of the information processing device 10 or the terminal device 20 in accordance with the program. In the present embodiment, the program can be recorded in a computer-readable recording medium. The computer-readable recording medium includes a non-transitory computer-readable medium, and is, for example, a magnetic recording device, a semiconductor memory, or the like. The program is distributed, for example, by selling, transferring, or lending a portable recording medium such as a DVD in which the program is recorded. Further, the program may be distributed by storing the program in the storage of the external server and transmitting the program from the external server to another computer. Further, the program may be provided as a program product. Part or all of the functions of the information processing device 10 or the terminal device 20 may be realized by a dedicated circuit corresponding to the control unit 11 or the control unit 21. That is, some or all of the functions of the information processing device 10 or the terminal device 20 may be realized by hardware.

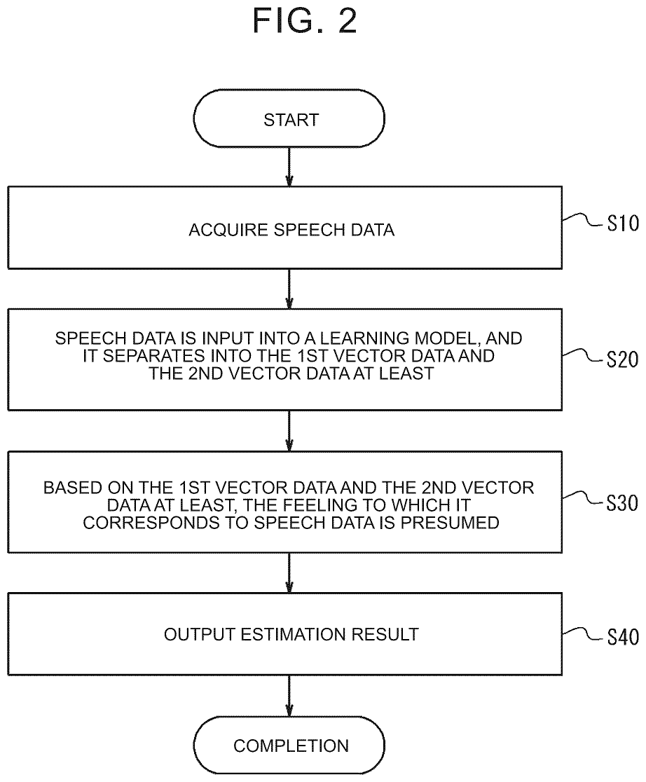

An operation of the information processing device 10 according to the present embodiment will be described with reference to FIG. 2. First, the control unit 11 of the information processing device 10 acquires speech data (S10). An arbitrary method can be adopted for acquiring the speech data. For example, the control unit 11 may acquire speech data via the input unit 13. Alternatively, the control unit 11 may acquire speech data from an external device or the like including the terminal device 20 via the communication unit 15 and the network 30. The speech data includes the voice of a specific speaker such as an opportunity. The speech data is not limited thereto, and may include any data such as telephone service with a customer. A particular speaker may be, for example, a customer, staff, etc., such as an opportunity. The business negotiation may be, for example, a business negotiation related to vehicle sales.

Next, the control unit 11 inputs the speech data to the learning model and separates the speech data into at least the first vector data and the second vector data (S20). The learning model is trained on the basis of a first loss function based on the difference between the linguistic information based on the speech data and the first vector data, a second loss function based on the symmetric learning or the asymmetric learning of the second vector data, and a third loss function minimizing the mutual information amount between the first vector data and the second vector data. In other words, the learning model is trained by the first loss function so that the difference is minimized based on the difference between the linguistic information based on the speech data and the first vector data. The learning model is also trained by a second loss function according to the symmetry or asymmetry between the data based on the symmetric or asymmetric learning of the second vector data. If the second loss function is a function based on symmetric learning, the symmetric learning may be simCLR. In such cases, the same sound is used as positive sample, and the different sounds are used as negative sample. Also, for example, if the second loss function is a function based on asymmetric learning, the asymmetric learning may be BYOL, SimSiam, or DINO. In this case, a speech segment shorter than the predetermined length is inputted to student, and a speech segment longer than the predetermined length is inputted to teacher. The learning model is also trained based on a third loss function that minimizes the amount of mutual information between the first vector data and the second vector data and separates the first vector data and the second vector data as far as possible. In the training of the third loss-function, CLUB or DiCy may be used. Note that the linguistic information based on the speech data may be transcribed data related to the speech data. Any method may be used for generating the transcribed data.

Subsequently, the control unit 11 estimates an emotion corresponding to the speech data based on at least the first vector data and the second vector data (S30). For example, the control unit 11 may input the first vector data and the second vector data to the first estimation model and the second estimation model, respectively, to estimate an emotion. The first estimation model and the second estimation model may be, for example, a logistic-regression or ECAPA-TDNN model.

Subsequently, the control unit 11 (S40) the estimation result of the emotion corresponding to the speech data. An arbitrary method can be adopted for the output processing of the estimation result. For example, the control unit 11 may transmit data related to the estimation result to the terminal device 20 via the communication unit 15, and output the estimation result by the output unit 24 of the terminal device 20. The control unit 21 may output the estimation result by a user interface displayed and output by the output unit 24.

Note that a pseudo label may be attached to a part of the teacher data used in training the first estimation model and the second estimation model instead of the label, and the first estimation model and the second estimation model may be trained by the semi-supervised learning. For example, more than half of the teacher data may be provided with pseudo labels instead of labels. The first estimation model may be trained by supervised learning, and only the second estimation model may be trained by semi-supervised learning. Here, when the learning model is trained by the first loss function, the first vector data becomes data corresponding to the linguistic information of the speech data. On the other hand, by the second loss function and the third loss function, the second vector data is adjusted so as to have a low correlation with the first vector data. In other words, the second vector data corresponds to data other than the linguistic information of the speech data (paralinguistic information and non-linguistic information). Here, the diversity related to the paralinguistic information and the non-linguistic information is low, and it is considered that the learning can be performed with a relatively small number of data.

As described above, the information processing device 10 inputs the speech data to the learning model, separates the speech data into at least the first vector data and the second vector data, and estimates the emotion corresponding to the speech data based on at least the first vector data and the second vector data.

According to such a configuration, the information processing device 10 can perform emotion estimation using at least two different vectors. The emotion estimation technique is improved in that emotions having different properties can be estimated and emotion gaps can be estimated in this way.

Table 1 shows the accuracy verification results of the first estimation model and the second estimation model. Here, a label of an expressive emotion (hereinafter, also referred to as a language label) and a label of an intrinsic emotion (hereinafter, also referred to as a psychological label) are attached to the teacher data. Accuracy verification of the first estimation model and the second estimation model is performed using the first vector data and the second vector data as inputs, respectively. If the language label and the psychological label do not match, F1 score of the psychological label is improved by 6 points when the second vector data is used than when the first vector data is used. On the other hand, F1 scoring of the linguistic labels improved by seven points when the first vector data was used, compared to when the second vector data was used. For example, when the language label and the psychological label differ from each other, a highly accurate emotion estimation result can be provided by using an estimation result having a higher F1 score.

TABLE 1

| | | Psychological | F1 scoring |
|---|---|---|---|
| | | labels ≠ F1 | of language |
| | F1 scoring for | scoring of | labels for |
| | psychological | psychological | psychological |
| | labels = | labels for | labels ≠ |
| | language labels | language labels | language labels |
| Estimation by the | 77% | 37% | 50% |
| first vector data | | | |
| Estimation with | 76% | 43% | 43% |
| second vector data | | | |

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, the configuration and operation of the information processing device 10 or the terminal device 20 may be distributed among a plurality of computers capable of communicating with each other.

Further, for example, in the present embodiment, the speech data is input to the learning model, is separated into at least two vectors, and the first vector data and the second vector data are used to estimate emotions having different properties of the two expressive emotions and the intrinsic emotions, respectively. For example, speech data may be input into a learning model and separated into three vector data. In this case, for example, each of an emotion based on the linguistic information, an emotion based on the paralinguistic information, and an emotion based on the non-linguistic information may be estimated by the three vector data.

What is claimed is:

1. An emotion estimation method that is executed by an information processing device, the emotion estimation method comprising:
acquiring speech data;
inputting the speech data into a learning model, and separating into first vector data and second vector data;
inputting the first vector data into a first estimation model and estimating an emotion based on linguistic information; and
inputting the second vector data into a second estimation model and estimating an emotion based on non-linguistic information, wherein
part of teacher data that is used when training the first estimation model and the second estimation model is imparted a pseudo label instead of a label, and the first estimation model and the second estimation model are trained by semi-supervised learning.

2. The emotion estimation method according to claim 1, wherein half or more of the teacher data is imparted pseudo labels instead of labels.

3. The emotion estimation method according to claim 1, wherein the first estimation model is logistic-regression or ECAPA-TDNN.

4. The emotion estimation method according to claim 1, wherein the second estimation model is logistic-regression or ECAPA-TDNN.
